(19) United States
(12) Patent Application Publication
(10) Pub. No.: US 2008/0025387 A1
(43) Pub. Date: Jan. 31, 2008

(54) INTELLIGENT MOVING ROBOT BASED NETWORK COMMUNICATION CAPABLE OF OUTPUTTING/TRANSMITTING IMAGES SELECTIVELY ACCORDING TO MOVING OF PHOTOGRAPHED OBJECT

(76) Inventors: Eul Gyoon LIM, Daejeon (KR); Ho Chul SHIN, Daejeon (KR); Dae Hwan HWANG, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/762,139

(22) Filed: Jun. 13, 2007

(30) Foreign Application Priority Data
Jul. 26, 2006 (KR) 10-2006-0070403

(51) Int. Cl. H04N 7/12; H04B 1/02

(52) U.S. Cl. 375/240.01; 455/91; 901/1

(57) ABSTRACT

A network-based mobile robot is provided. The mobile robot includes a video encoder, a bit rate analysis unit, an inference unit, and a switch unit. The video encoder encodes an image with a variable bit rate to output bitstreams in a frame unit. The bit rate analysis unit analyzes a size of the bitstreams per frame from the video encoder. The inference unit infers a bitstream output start point and end point by comparing the size of the bitstreams to a predetermined reference value based on the analyzing result and determines whether an object in the bitstreams per frame moves or not. The switch unit selectively starts and ends the inputted image output operation to an internal image processing processor and the bitstream output operation to a remote server that is connected via a network and perform image processing, based on the inferring result of the inference unit.

### CLAIM OF PRIORITY

This application claims the benefit of Korean Patent Application No. 10-2006-70403 filed on Jul. 26, 2006 in the Korean Intellectual Property Office, the disclosure of which is incorporated herein by reference.

### BACKGROUND OF THE INVENTION

1. Field of the Invention

The present invention relates to a network-based intelligent moving robot, and more particularly, to a network based intelligent moving robot for capturing an image using a camera and transmitting the captured image to a remote control server, and a method of transmitting image data using the same.

2. Description of the Related Art

In general, a conventional robot collects information using a ultrasonic wave sensor and a camera mounted thereto, and analyzes the collected information through an internal processor. That is, the conventional robot needs a high performance processor for processing the collected information. Such a high performance processor is very expensive and generally generates a large amount of heat due to a high clock speed, thereby requiring additionally a cooling system. Therefore, if the conventional robot is made as a batter operated mobile type robot, the conventional robot has disadvantages as described above.

A conventional robot equipped with a video camera recognizes a facial expression or a motion made by a user, and reacts according to the recognizing result. The conventional robot drives a wheel or an arm by detecting the location of an object. In order to make such a move, the robot requires a real time image processing. In order to process high quality image in real time, the robot must equip a plurality of general purpose processors.

In order to overcome the shortcomings of the conventional robot, a network system for controlling a mobile robot was introduced. The network-based robot control system includes a mobile robot and a remote server. The mobile robot equips an embedded processor with minimum capability that can obtain information through various sensors including a video camera and transmit the obtained information to other computer, for example, a server. The remote server receives and analyzes the obtained information from the mobile robot, and remotely control the mobile robot. Such a mobile robot refers to a network-based mobile robot.

FIG. 1 is a block diagram illustrating a network based remote data processing system formed of a conventional network-based mobile robot and a remote server having a capability of processing collected data transmitted from the mobile robot.

As shown in FIG. 1, the network-based remote data system includes a network-based mobile robot 10, and a remote server 30 communicating with the network-based mobile robot 10 through a wireless network 20. The network-based mobile robot 10 collects corresponding data and transmits the collected data to the remote server 30. The network-based mobile robot 10 also receives the results of processing the collected data from the remote server 30 and controls corresponding operations thereof based on the received results. That is, the network-based mobile robot 10 does not process the collected data although the network-based mobile robot 10 collects the corresponding data and controls motions according to the processing result of the collected data.

Particularly, the network-based mobile robot 10 transmits sensor data 14 collected through a sensor 12 to the remote server 30 through a wireless network 20 using a packet handler 16. The remote server 30 processes the sensor data packets transmitted from the network-based mobile robot 10 through a data processor 32. Accordingly, the controller 34 of the remote server 30 transmits an instruction packet, which is generated according to the processing results from the data processor 32, to the network-based mobile robot 10 through a wireless network 20.

The network-based mobile robot 10 receives the instruction packet from the remote server 30 through the packet handler 16, and provides the received instruction packet to an operation controller 18. The operation controller 18 of the network-based mobile robot 10 controls the corresponding operation according to the received instruction packet.

As described above, the network-based mobile robot 10 uses an embedded processor which is cheap and use less power because the network-based mobile robot 10 does not process the collected data. Therefore, a unit cost of the network-based mobile robot 10 is reduced, the heat generation is reduced, and a battery lift time extends. The network-based mobile robot 10 has an advantage of fast booting in comparison with a stand-alone robot including a computer with a general purpose operation system (OS) installed.

The remote server 30 does not have limitations of volume, weight and cost, and can be built as high-powered system through clustering. The remote server 30 can process high quality image at a high speed compared to any stand-alone robots. Additionally, a plurality of network-based robots 10 can share single remote server 30, thereby reducing an average unit cost of the remote server 30 and a cost of building the system.

The network-based mobile robot 10 transmits the sensor data such as images to the remote server 30 through a wireless network 20. Generally, computer image analysis requires high resolution color images, for example, 320 horizontal pixels×240 vertical pixels. Also, user motion detection requires a video with higher frame rate than 15 frames per second, and image-based navigation requires video with even more higher frame rate that 15 frames per second. Therefore, the transmit amount of image data is greater than that of other sensor data of the conventional robot.

Since the network-based mobile robot 10 is mobile type, the network-based mobile robot 10 uses the wireless network having less reliability than a wired network. If the image data is transmitted as it is, network transmission errors make data transmission impossible. Therefore, the network-based mobile robot 10 compresses the image data and transmits the compressed image data to the remote server 30. The remote server 30 decompresses the received image data, reproduces an image from the decompressed image data, and analyzes and processes the reproduced image.

Although images can be compressed in a frame unit, it is preferable to use a video format that encodes differences between a current frame and a previous frame as like a Moving Picture Experts Group 4 (MPEG 4) or H.263.

FIG. 2 is a block diagram illustrating a network-based remote image data processing system for processing image data using a mobile robot.

As shown, the network-based remote image data processing system includes a network-based mobile robot 40, and a remote server 70 for receiving image bitstreams transmitted from the network-based mobile robot 40 through a wireless network 20, and processing the received image streams.

The network-based mobile robot 40 captures an image through a camera 42 and encodes the captured image through a video encoder 50. Then, the network-based mobile robot 40 transmits the encoded image as a bitstream to the remote server 70 through the wireless network 20. The remote server 70 decodes the bitstreams transmitted from the network-based mobile robot 40 through a video decoder 72 and restores an original image from the decoded data. Then, the remote server 70 recognizes a face, a motion, or a landmark through analyzing the restored image using an image processor 74.

The video encoder of the network-based mobile robot 40 can be a typical video encoder chip, or a processor embedded hardware logic, and the video decoder of the remote server 70 can be a software function.

The network-based mobile robot 40 cannot process image data by itself because the network-based mobile robot 40 uses a low cost embedded processor. Therefore, the network-based mobile robot 40 must transmit all image data to the remote server 70. Although there is no users or no motion in visual field of a camera 42 of the network-based mobile robot 40, the network-based mobile robot 40 can determine that the related image data is useless after the remote server 70 analyzes the image data. The analyzed image data, however, already occupies a portion of a network bandwidth from the network-based mobile robot 40 to the remote server 70, and wastes resources in a central processing unit (CPU) of the remote server 70.

As described above, the conventional network-based remote image data processing system transmits collected image data to the remote server 70 regardless of necessity of the collected image data. Therefore, the limited wireless resources are wasted, and the processing power of the remote server 70 becomes degraded due to unnecessary image processing.

All images are meaningful if the network-based mobile robot 40 performs image-based navigation. In general operation, a captured image can be discerned as a useless image if the captured image does not include any motions or variation. On the contrary, if the captured image includes the motions of a object, or variations, the capture image is discerned as the useful image data and transmitted to the remote server for analysis.

As described above, there are many researches in progress for detecting motion from images or detecting variation of images in a conventional security image monitoring system, a digital video recording field or a video search field. Such a technology is used to determine an intruder by detecting motions in images, or is used to detect a frame having serious variation in images and shows the detected frame as a key frame for high speed searching.

The conventional system for detecting a motion or a scene change of images captured by camera uses various methods for detecting differences between a previous image and a current image. A system using an original image as it is performs a differential image calculation using a luminance signal difference between images, or determines whether a motion is made or not by dividing one image frame into a plurality of macro blocks and calculating a motion vector of each of macro blocks. A system using video hardware encoder uses various information obtained by decoding the video encoding result to detect differences between a previous image and a current image.

In case of the differential image calculation, it is difficult to discriminate an image difference made by environment variation from that made by the motion of an object. Also, it is seriously influenced by a camera noise, and requires many pre-processes and post-processes, thereby increasing the computation amount.

In order to calculate a motion vector of a macro block unit, high level repeated calculations such as pattern matching is required. In a typical camera resolution, it is impossible to calculate such a computation in software manner as fast as a frame rate of a camera, for example, maximum 30 frames per second. Also, it is difficult to obtain dedicated hardware to calculate motion vectors or a video hardware encoder outputting a motion vector while encoding video.

In case of calculate a motion vector by decoding the video encoding result, no dedicated hardware or no hardware video decoder outputting a motion vector was introduced. Therefore, it must use software decoder. It is impossible to calculate the motion vector using a low cost embedded processor in real time.

As described above, it is impossible to apply the conventional technology detecting motion difference or image variation from image into the network-based mobile robot 40 using the low cost and low performance embedded processor without dedicated hardware.

### SUMMARY OF THE INVENTION

The present invention has been made to solve the foregoing problems of the prior art and it is therefore an aspect of the present invention is to provide a network-based mobile robot for selectively transmitting image data in consideration of a motion of a captured object to a server that processes the captured image data, and a method thereof.

Another aspect of the invention is to provide a network-based mobile robot for selectively transmitting image data to a server that processes image data by simply determining whether an object in a captured image makes a motion or not, and a method thereof.

Still another aspect of the invention is to provide a network-based mobile robot for reducing wastes of wired or wireless network resources and reducing data processing load of a server by selectively transmitting image data to a server.

According to an aspect of the invention for realizing the object, the invention provides a network-based mobile robot. The network-based mobile robot includes: a video encoder for encoding an inputted image with a variable bit rate to output bitstreams in a frame unit; a bit rate analysis unit for analyzing a size of the bitstreams per frame outputted from the video encoder; an inference unit for inferring a bitstream output start point and a bitstream output end point by comparing the size of the bitstreams to a predetermined reference value based on the analyzing result of the bit rate analysis unit and determining whether an object in the bitstreams per frame moves or not; and a switch unit for selectively starting and ending the inputted image output operation to an internal image processor and the bitstream output operation to a remote server that is connected via a network and perform image processing, based on the inferring result of the inference unit.

Preferably, the video encoder may compress and convert the input image into at least one of motion picture formats such as MPEG, H.263, and H.264 in a real time to encode the image with the variable bit rate.

The bit rate analysis unit may analyze the size of the bitstreams per frame outputted from the video encoder by using at least one of time series analysis and frequency analysis. Herein, the time series analysis analyzes the size of the bitstreams per frame by using a sample average, a sample standard deviation, a sample maximum value, and a sample minimum value for N(N means the number of samples) samples that are inputted the latest among the bitstreams per frame. The frequency analysis analyzes the size of the bitstreams per frame outputted from the video encoder by performing FFT conversion on N samples that are inputted the latest among the bitstreams per frame.

The bit rate analysis unit may perform filtering on N samples that are inputted the latest among the bitstreams per frame to remove noises from the bitstreams before analyzing the size of the bitstreams per frame.

The switch unit may stop the bitstream output operation when the remote server determines that the object does not move by comparing the value derived from the bitstream size of the next image to a predetermined threshold value and outputs a bitstream output stop instruction.

When the bitstream output stop instruction is inputted, the inference unit may update the threshold value based on the instruction.

The inputted image may be motion picture data captured in real time by a camera.

According to another aspect of the invention for realizing the object, there is provided a network-based mobile robot including: a video encoder for encoding an inputted image with a variable bit rate to output bitstreams in a frame unit; a bit rate analysis unit for analyzing a size of the bitstreams per frame outputted from the video encoder; an inference unit for inferring a bitstream output start point by comparing the size of the bitstreams to a predetermined reference value based on the analyzing result of the bit rate analysis unit and determining whether an object in the bitstreams per frame moves or not; and a switch unit for starting the bitstream output operation to a remote server that is connected via a network and performs image processing, based on the inferring result of the inference unit, and ending the bitstream output operation when a transmit end instruction is inputted from the remote server through a transmit end point detecting process for the bitstreams.

According to another aspect of the invention for realizing the object, there is provided a network-based mobile robot including: a video encoder for encoding an input image with a variable bit rate to output bitstreams in a frame unit; a bit rate analysis unit for analyzing a size of the bitstreams per frame outputted from the video encoder; an inference unit for inferring a bitstream output start point by comparing the size of the bitstreams to a predetermined reference value based on the analyzing result of the bit rate analysis unit and determining whether an object in the bitstreams per frame moves or not; a first switch unit for starting the image output operation in response to the inferring result of the inference unit, and ending the image output operation when a image output end instruction is inputted; a detection unit for detecting a bitstream output start point and a bitstream output end point by comparing the next image of the outputted image from the first switch unit to a predetermined value and determining an object in the image moves or not, and inputting the image output end instruction to the first switch unit based on the image output end point; and a second switch unit for starting the bitstreams output operation to a remote server that is connected via a network and performs image processing, based on the detecting result of the detection unit, and ending the bitstream output operation when a transmit stop instruction is inputted from the remote server through a transmit end point detecting process for the bitstreams.

When the bitstream transmit stop instruction is inputted from the remote server, the inference unit may update the threshold value based on the instruction. When the bitstream transmit stop instruction is inputted from the remote server, the detection unit may update the threshold value based on the instruction.

According to another aspect of the invention for realizing the object, there is provided a method of transmitting image data using a network-based mobile robot, including the steps of: encoding an input image with a variable bit rate to output bitstreams in a frame unit; analyzing a size of the outputted bitstreams per frame; comparing the size of the bitstreams to a predetermined reference value based on the analyzing result, and determining whether an object in the bitstreams per frame moves or not; inferring a bitstream output start point based on the determining result; starting the bitstream output operation to a remote server that is connected via a network and performs image processing based on the inferring result; and ending the bitstream output operation when a transmit stop instruction is inputted from the remote server through a transmit end point detecting process for the bitstreams.

Preferably, the method may further comprise the steps of: determining whether a bitstream output stop instruction is inputted or not by comparing the value derived from the bitstream size of the next image to a predetermined threshold value and determining an object moves or not; and ending the bitstreams output operation when the determination is made that the bitstream output stop instruction is inputted.

In addition, the method may further comprise the step of when the bitstream output stop instruction is inputted, updating the reference value based on the instruction.

According to another aspect of the invention for realizing the object, there is provided a method of transmitting image data using a network-based mobile robot, including the steps of: encoding an input image with a variable bit rate to output bitstreams in a frame unit; analyzing a size of the outputted bitstreams per frame; comparing the size of the bitstreams to a predetermined reference value based on the analyzing result, and determining whether an object in the bitstreams per frame moves or not; inferring a bitstream output start point and a bitstream output end point based on the determining result; outputting selectively the input image to an internal image processor and the bitstreams to a remote server that is connected via a network and performs image processing, based on the inferring result.

According to another aspect of the invention for realizing the object, there is provided a method of transmitting image data using a network-based mobile robot, including the steps of: encoding an input image with a variable bit rate to output bitstreams in a frame unit; analyzing a size of the outputted bitstreams per frame; comparing the size of the bitstreams to a predetermined reference value based on the analyzing result, and determining whether an object in the bitstreams per frame moves or not; inferring a bitstream output start point based on the determining result; starting the image output operation in response to the inferring result; detecting a bitstream output start point and an image output end point by comparing the value derived from the bitstream size of the next image to a predetermined threshold value and determining an object in the image moves or not, and controlling the image output end based on the detected image output end point; starting the bitstreams output operation to a remote server that is connected via a network and performs image processing, based on the detected output start point; and stopping the bitstream output operation when a transmit stop instruction is inputted from the remote server through a transmit end point detecting process for the bitstreams.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a network based remote data processing system formed of a conventional network-based mobile robot and a remote server having a capability of processing collected data transmitted from the mobile robot;

FIG. 2 is a block diagram illustrating a network based remote image data processing system for processing image data using a mobile robot;

FIG. 3 is a block diagram illustrating a typical MPEG video encoder;

FIG. 4 is a graph of a bitstream per frame of a MPEG 4 video encoder 50 of FIG. 3 used in the present invention;

FIG. 5 is a graph illustrating an event generated in each peak region of a bitstream graph of FIG. 4;

FIG. 6 is a graph showing frequency distribution of bitstream sizes when there is no motion in images (frame 1 to 780) in FIG. 4 and FIG. 5;

FIG. 7 is a graph showing frequency distribution of bitstream sizes when there are motions in images (frame 783 to 1122) in FIG. 4 and FIG. 5;

FIG. 8 is a graph showing frequency distribution of bitstream sizes when there are motions in images (frame 3869 to 4929) in FIG. 4 and FIG. 5;

FIG. 9 is a block diagram illustrating a network-based mobile robot system for selectively outputting a captured image based on a motion of an object in an image according to a first embodiment of the present invention;

FIG. 10 is a block diagram illustrating a network-based mobile robot system for selectively outputting a captured image based on a motion of an object in an image according to a second embodiment of the present invention;

FIG. 11 is a block diagram illustrating a network-based mobile robot system for selectively outputting a captured image based on a motion of an object in an image according to a third embodiment of the present invention;

FIG. 12 is a block diagram illustrating a stand-alone robot system for selectively outputting a captured image based on a motion of an object in an image according to a fourth embodiment of the present invention;

FIG. 13 is a flowchart illustrating a method of selectively outputting a captured image based on a motion of an object in an image using a network-based mobile system according to an embodiment of the present invention; and

FIG. 14 to FIG. 19 are graphs for showing examples of detecting a start point extracted by extracting a predetermined portion of image data of FIG. 4 and FIG. 5 through a network-based mobile robot 100 according to an embodiment of the present invention.

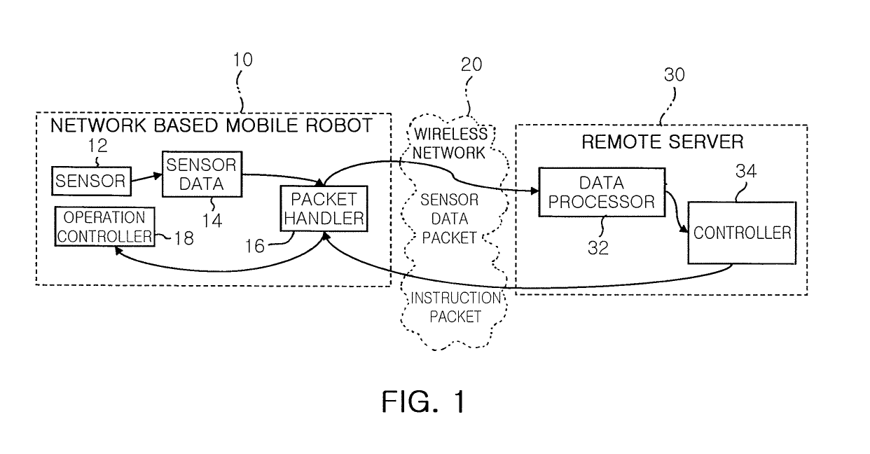

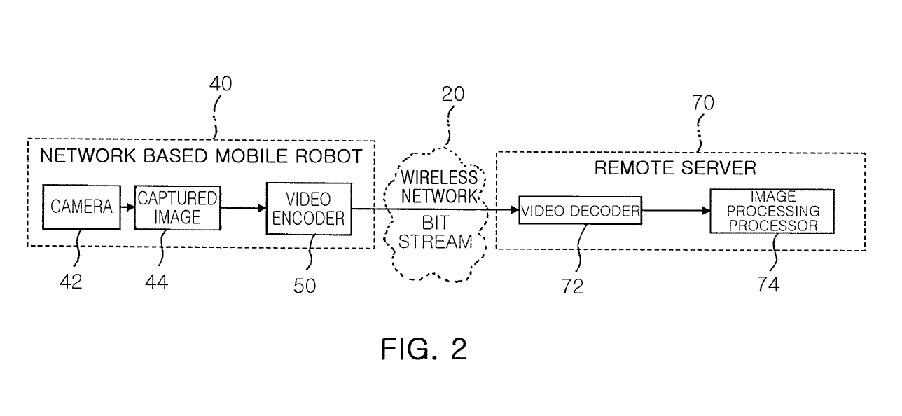

### DETAILED DESCRIPTION OF THE PREFERRED EMBODIMENT

Preferred embodiments of the present invention will now be described in detail with reference to the accompanying drawings.

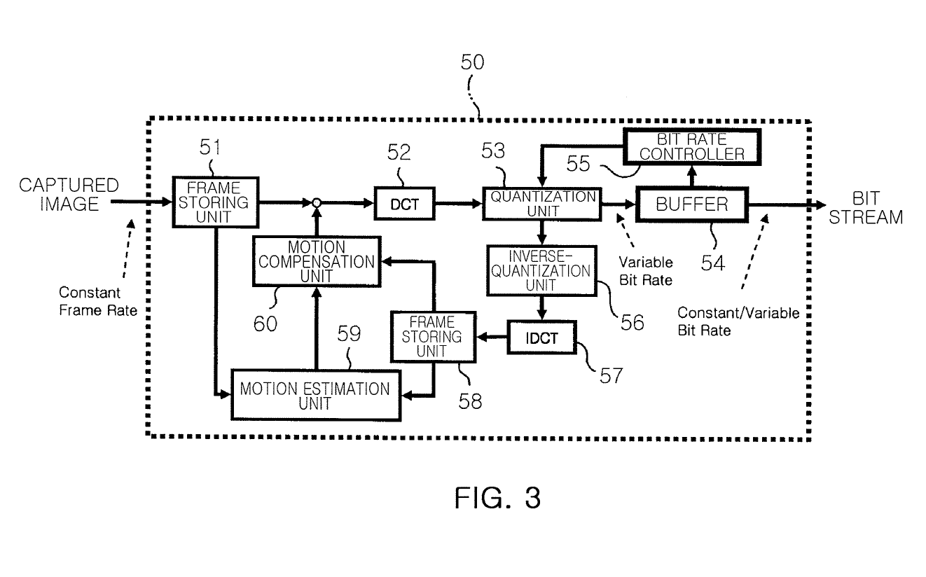

FIG. 3 is a block diagram illustrating a typical MPEG video encoder.

As shown in FIG. 3, a video encoder 50 receives a captured image and stores it to a frame storing unit 51. The frame storing unit 51 outputs the frames of the captured image to a discrete cosine transform (DCT) 52. The DCT 52 performs DCT on the image data and outputs the result thereof to a quantization unit 53. The quantization unit 53 quantizes a DCT coefficient according to a quantization step size and outputs the result thereof to a buffer 54.

The buffer 54 temporally stores the quantized data and outputs the quantized data. The buffer 54 provides a buffering state of the buffer 54 to a bit rate controller 55. The bit rate controller 55 calculates a quantization parameter according to the buffering state information of the buffer 54 and provides the calculated quantization parameter to the quantization unit 53.

The quantization unit obtains a quantization step size from the input quantization parameter, and quantizes the DCT coefficient. Accordingly, the quantization unit 53 controls a data generation rate, that is a data bit rate, by dynamically changing the quantization step size according to the quantization parameter.

An inverse-quantization unit 56 inverse-quantizes the quantized DCT coefficient and outputs the inverse-quantized DCT coefficient to an IDCT 57. The IDTC 57 performs an inverse DCT on the inverse-quantized DCT coefficient and stores the result in the frame storing unit 58.

A motion estimation unit 59 estimates a motion vector using the image data outputted from the frame storing unit 51 and a reference image data stored in the frame storing unit 58, and outputs the estimated motion vector to a motion compensation unit 60.

The motion compensation unit 60 compensates a motion using a previous frame read from the frame storing unit 58 according to the estimation result of the motion estimation unit 59. The compensated frame data is subtracted from the data outputted from the frame storing unit 51 and the subtracting result is outputted to the DCT 52.

The video encoder 50 can perform a setup operation related to a target frame rate and a target quality as described above. The setup value of a usable target quality in a MPEG 4 or H.263 is a quantization value. Also, the video encoder 50 can select one of a constant bit rate (CBR) and a variable bit rate (VBR) as the target quality setup value.

The variable bit rate mode is to output a bitstream varied in proportional to the level of variation between a previous frame and a current frame and the complexity of a current frame.

In case of transmitting a bitstream encoded based on the variable bit rate mode through a transmission network with a transmit rate strictly limited, the image quality is limited by the maximum bit rate. In order to overcome such a shortcoming, a constant bit rate transmission mode was introduced. In the constant bit rate transmission mode, a predetermined amount of frames are stored in the buffer 54 and the encoding quality of a next frame changes according to the size of a previous frame bitstream, thereby adjusting an average bitstream size to the available transmission amount of a transmission network. Although the constant bit rate transmission mode has a shortcoming that the encoded image quality changes by frames according to the variation level of images between frames and the complexity, the constant bit rate mode is generally used since conventional video applications commonly use a transmission medium limiting a transmit rate. In the typical video encoder, one of the variable bit rate mode and the constant bit rate mode can be selected.

The video encoder 50 may compress the data of current frame only regardless of the difference between the current frame and a previous frame in order not to be influenced by previous error that may occur during transmission or reading or writing. An interframe encoding denotes encoding a difference between a current frame and a previous frame. An intra frame denotes encoding a current frame without the difference between the current frame and the previous frame.

The size of inter frame encoded bitstream is in proportional to the motion between frames and the complexity. Since the motion is changes between current frame and previous frame, the size of the intra frame encoded bitstream is only in proportion to the complexity of a current image frame. A typical video encoder can set the frequency of intra frame encoding, and can select one encoding scheme from the inter frame encoding and the intra frame encoding before encoding each frame.

If a portion of data is damaged by errors generated while transmission, reading or writing, a wrong image is left on a location of an image obtained from decoding if only the inter frame encoding is selected for encoding. In order to automatically correct such as error, the number of macro blocks is sequentially updated in a macro block unit in a frame. It refers to a cyclic intra refresh (CIR). A typical video encoder can setup the number of macro blocks that can be updated at once by the CIR function. Although there is no image variation between frames, the size of the bitstream per frame can change in the variable bit rate mode. Since a motion variation is not large in consideration of a size of bitstream increasing by generated motions and it has cyclic property, the influence of the complexity difference between macro blocks can be filtered.

In the present embodiment, the video encoder 50 uses a variable bit rate mode and basically uses only inter frame encoding. When video data is encoded based on the inter frame encoding and the encoded video data is outputted in a variable bit rate mode, the outputted bitstream includes difference information between a previous frame and a current frame, and the size of bitstream increase if the motion level becomes greater.

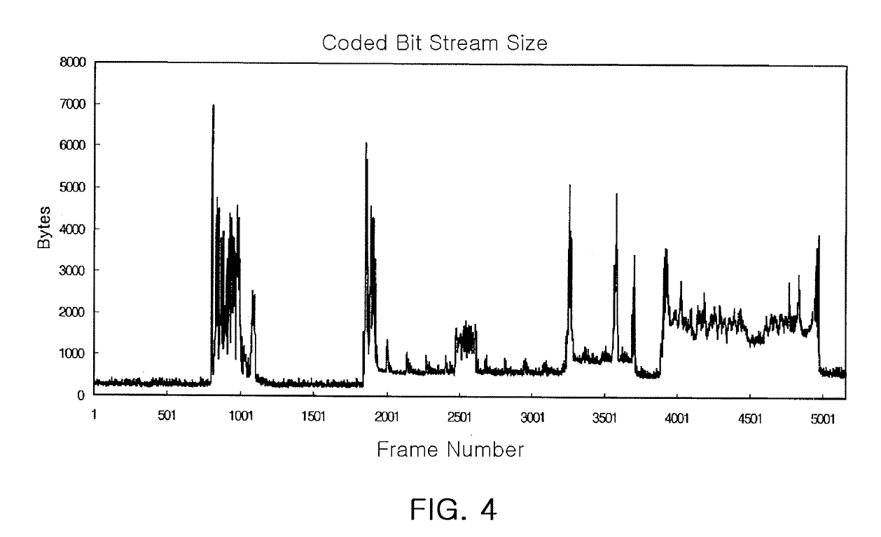

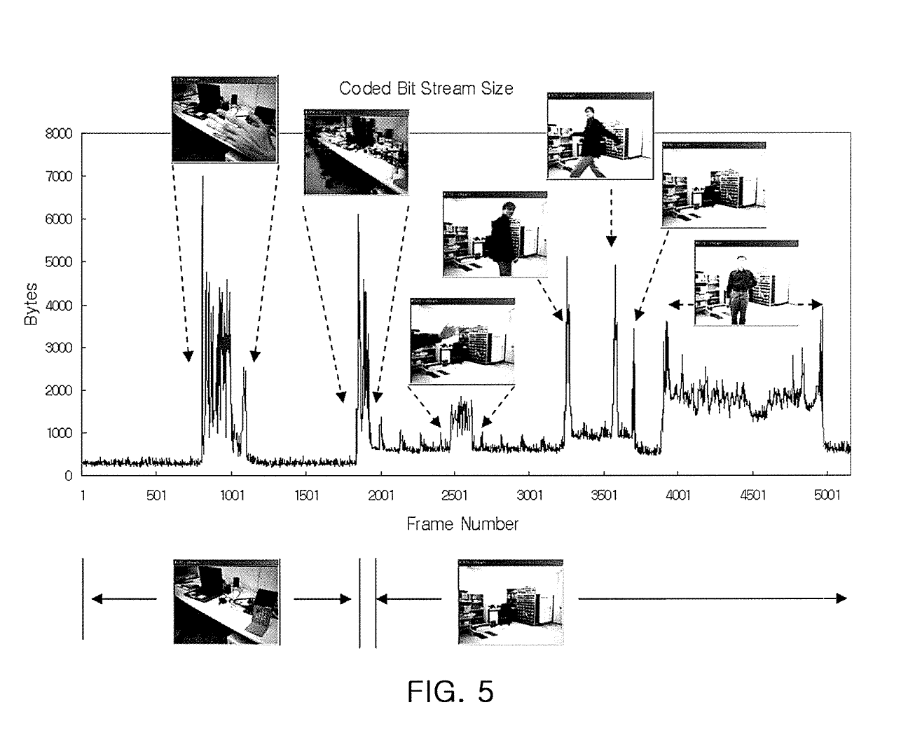

FIG. 4 is a graph of a bitstream per frame of a MPEG 4 video encoder 50 of FIG. 3 used in the present invention. FIG. 5 is a graph illustrating an event generated in each peak region of a bitstream graph of FIG. 4.

The resolution used in the video encoder 50 is about 320 horizontal pixels and 240 vertical pixels, and is encoded in a rate of 28 frames per second. As shown, the camera of a mobile robot photographs a desk before outputting a first peak. That is, since the camera photographs an object at rest, there is no change occurred in captured images. Therefore, the variation occurs less than a reference level in bytes of a bitstream. If a hand is appeared front of the camera of the robot, the size of bitstream abruptly increases, thereby forming the first peak at about a 1001^{st} frame. If the hand is disappeared, the size of the bitstream is dropped to about a previous level.

Afterward, a peak is shown at about 2001^{st} frame. It occurs when a scene changes because the camera of the mobile robot moves. In this case, overall scene brightness and complexity change. Therefore, the size of bitstream after the movement of the camera differs compared to a previous value.

Cyclic peaks shown from the 2001^{st} frame to the 3001^{st} frame are generated by CIR. A peak around the 2501^{st} frame is generated because hands are appeared in front of the camera. Two peaks around the 3501^{st} frame are generated by a person who crosses the scene of the camera. Peaks after then are generated while changing overall brightness by auto exposure correcting function of a camera. Bitstreams from the 4001^{st} frame to the 5001^{st} frame increase because a person is appeared in front of the camera and makes motions toward the camera.

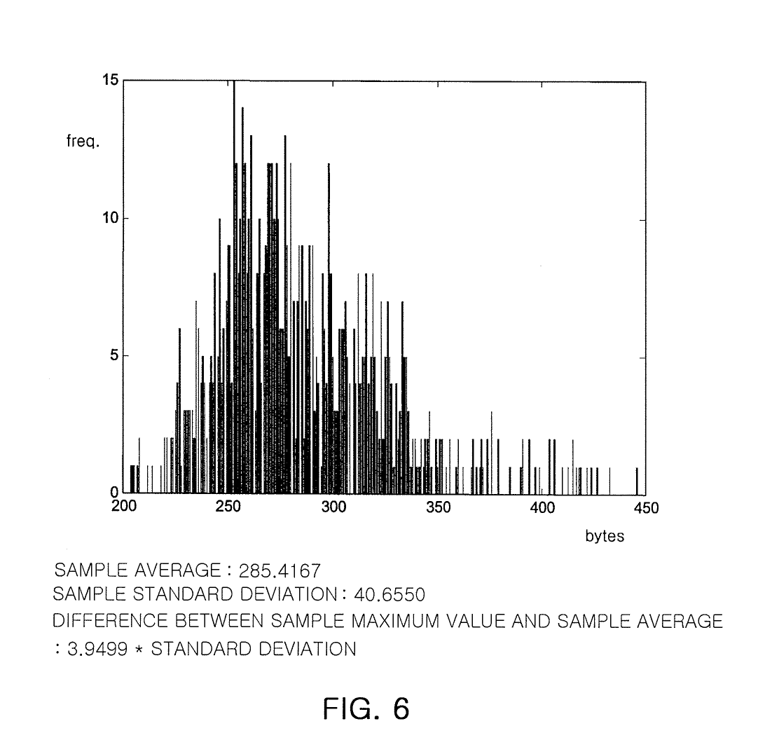

FIG. 6 is a graph showing frequency distribution of bitstream sizes when there is no movement in images (frame 1 to 780) in FIG. 4 and FIG. 5.

As shown, the average of samples is 285, and a sample standard deviation σ is about 41. All samples are present within +4 σ from a sample average in the frequency distribution of the bitstream size.

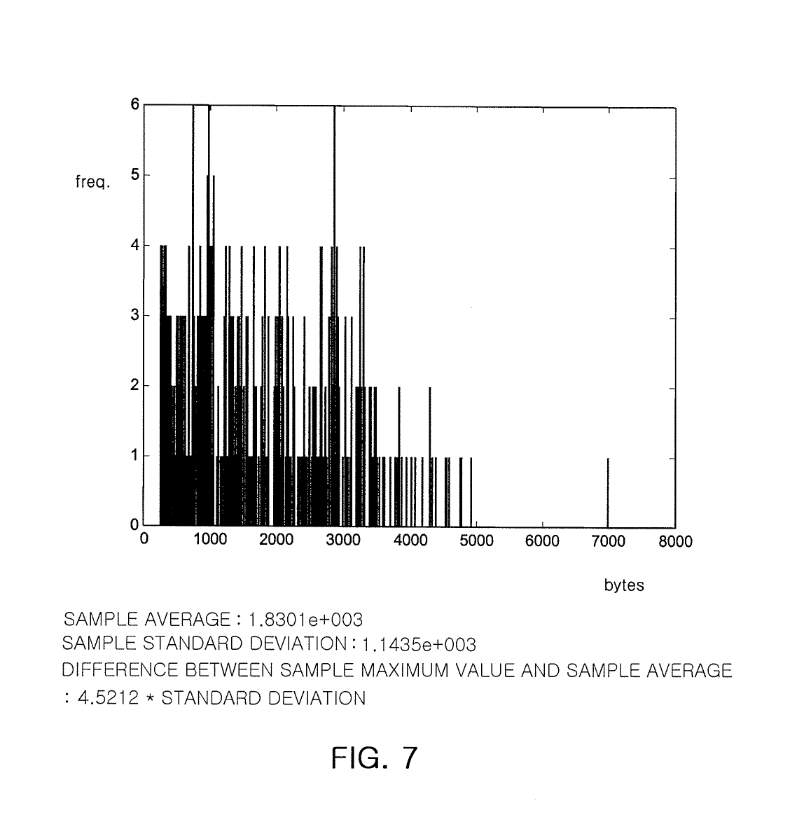

FIG. 7 is a graph showing frequency distribution of bitstream sizes when an object moves in an image (frame 783 to 1122) in FIG. 4 and FIG. 5.

As shown, the average of samples is 1803, and a sample standard deviation σ is about 1144 in the frequency distribution of the bitstream sizes. Compared to FIG. 6, the average and the standard deviation increase.

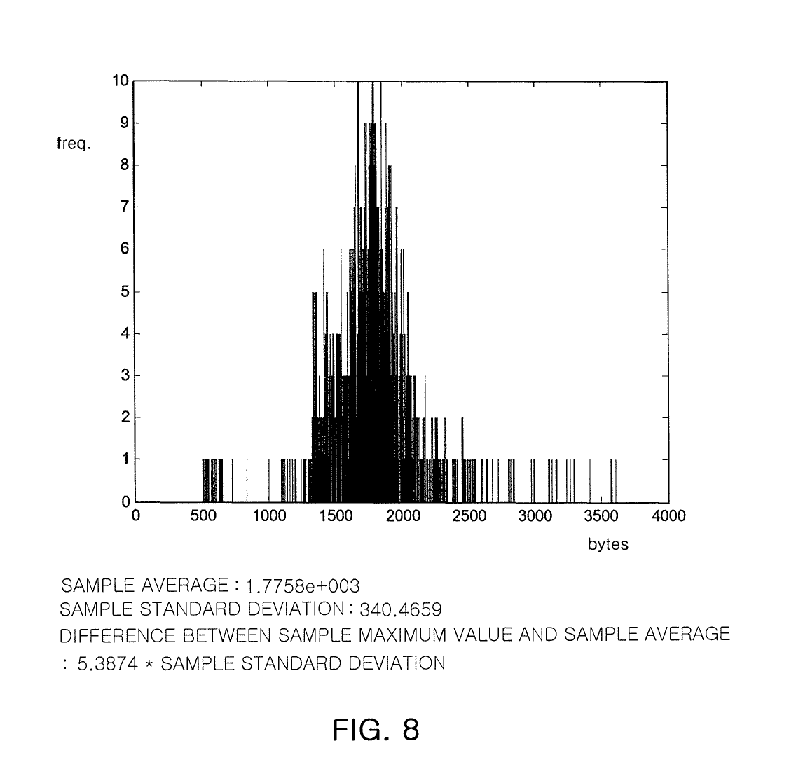

FIG. 8 is a graph showing frequency distribution of bitstream sizes when an object moves in an image (frame 3869 to 4929) in FIG. 4 and FIG. 5.

As shown, the average of samples is 1776, and a sample standard deviation σ is about 340 in the frequency distribution of the bitstream sizes. The difference between FIG. 7 and FIG. 8 is a difference between ratios of regions where the movement is reduced in a captured image from a camera. For example, the scattering increases as the moving region increase as shown in FIG. 7.

As described above, when an object moves in an image, the size of bit rate per frame abruptly increases compared to that in a static state. In the present embodiment, the motion level of an object in an image is determined by analyzing the size of bit rates per frame, and it decides whether an input captured image is transmitted to a remote server or not according to the determined motion level.

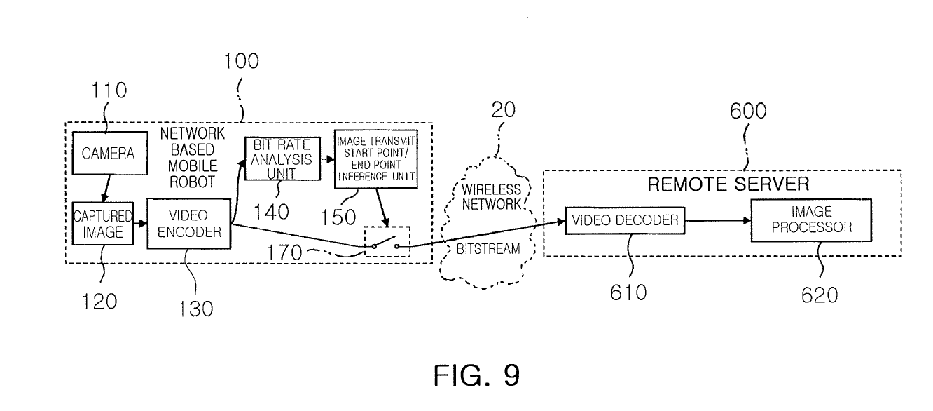

FIG. 9 is a block diagram illustrating a network-based mobile robot system for selectively outputting a captured image based on a motion of an object in an image according to a first embodiment of the present invention.

As shown, the network-based mobile robot 100 includes a camera 100 for photographing an object, a video encoder 130 for encoding the captured image 120 in a variable bit rate vide encoding mode, a bit rate analysis unit 140 for analyzing a size of the encoded variable bit rate bitstream, a image transmit start point/end point inference unit 150 for inferring a start point and an end point of transmitting bitstream by determining a motion of an object in an image based on the analyzed size of bitstream, and a switch unit 170 for outputting variable bit rate bitstreams outputted from the video encoder 130 to a remote server 600 according to the result of inferring of the start point and the end point.

When a bitstream is transmitted from the network-based mobile robot 100 to the remote server 600 through the wireless network 200, the remote server 600 decodes the received bitstream through a vide decoder 610.

In order to determine the variation of the bitstream size according to the present embodiment, the bit rate analysis unit 140 receives the number of bytes of bitstream from the video encoder 130 as a result of coding of every frame. The bit rate analysis unit 140 internally includes a buffer (not shown) that can store all bitstream sizes cyclically increased by CIR, thereby storing the number of bytes of the last N bitstreams as samples. When the bit rate analysis unit 140 receives the number of bytes of bitstreams when a new frame is encoded, the bit rate analysis unit 140 updates the N bitstream byte number samples stored in the buffer with the received byte number in first in and first out manner. The bit rate analysis unit 140 performs a time series analysis of a sample average, a sample standard deviation, a sample maximum value, and a sample minimum value. Additionally, the bit rate analysis unit 140 performs a FFT on samples. Also, the bit rate analysis unit 140 performs filtering on a predetermined number of latest samples so that the bit rate analysis unit 140 may exclude the influence of the noise between bitstreams of a current frame.

Image transmit start point/endpoint inference unit 150 sets an inference range of excluding the influence from variation by a noise or CIR based on the analysis result data of the bit rate analysis unit 140. The image transmit start point detect/end point inference unit 150 infers that variation occurs in an image captured from the camera 100 of the mobile robot if the newly input bitstream size or the filter passed value exceeds the set inference range. That is, a user makes a motion in front of the camera 100 of the mobile robot, or a user moves around the view field of the camera 100. Accordingly, the image transmit start point/end point inference unit 150 detects and judges the motion of an object in the captured image using the size of the variable bit rate bitstream.

As described above, the network-based mobile robot 100 transmits the image data of the captured video to the remote server 600 in the first embodiment of the present invention. The mobile robot 100 includes the image transmit start point/end point inference unit 150 to allows the mobile robot 100 to determine whether the bitstreams of the image data of the captured video are transmitted or interrupted. Herein, if the image transmit start point/end point inference unit 150 infers that the motion of an object is not made in the captured image by detecting a transmission end point as like inferring the transmission start point of the bit rate, the transmission of the bitstream is automatically interrupted through the switch unit 170.

The bit rate analysis unit 140 for analyzing the size of the variable bit rate bitstream and the image transmit start point/end point inference unit 150 may be embodied in various structures according to its purposes as follows.

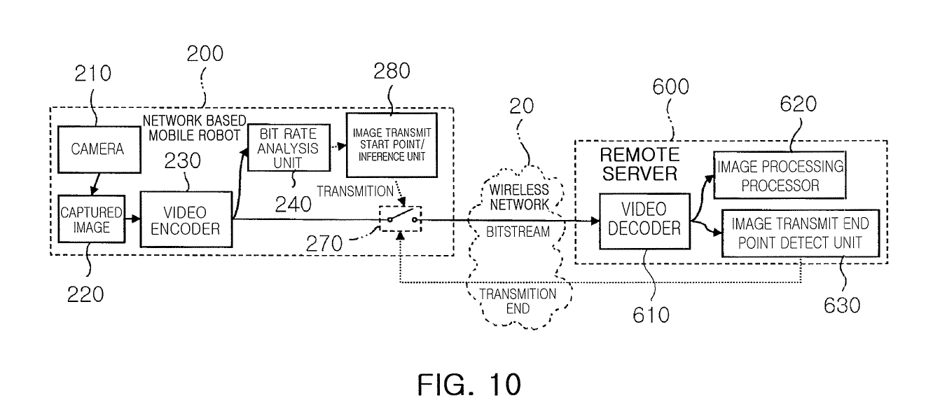

FIG. 10 is a block diagram illustrating a network-based mobile robot system for selectively outputting a captured image based on a motion of an object in an image according to a second embodiment of the present invention.

As shown, the network-based mobile robot 500 transmitting video data to the remote server 600 includes a image transmit start point inference unit 280 to allow the mobile robot 200 to determine detecting of a transmission start point of a video bitstream beside of including a camera 210, a vide encoder 230, a bit rate analysis unit 240 as like that in FIG. 9. If the image transmit start point inference unit 280 detects the transmission start point, the switch unit 270 transmits the variable bit rate bitstreams encoded and outputted from the video encoder 230 through a wireless network 20.

In the present embodiment of the present invention, the remote server 600 includes a transmission end point detecting process routine to determine a transmission end point and to inform that to the mobile robot 200 in order to interrupt the transmission of the bitstream. Accordingly, the switch unit 270 ends the transmission of the bitstream.

In the present embodiment, the remote server 600 includes a video decoder 620 for decoding bitstreams transmitted from the mobile robot 500, an image processing processor (routine) 620 for analyzing decoded image data, and an image transmit end point detector 630 for detecting a transmission end point of a bitstream from the decoded image data.

In the present embodiment, the routine of detecting the end point of the bitstream in the image transmit end point detecting unit 630 can detect whether an object moves or not using the information obtained while decoding video, and can detect the video transmission end point by referring to a return value from an image analysis routine such as detecting a face or recognizing a predetermined motion. That is, if the return value has no meaning, it will be determined as the image transmit end point.

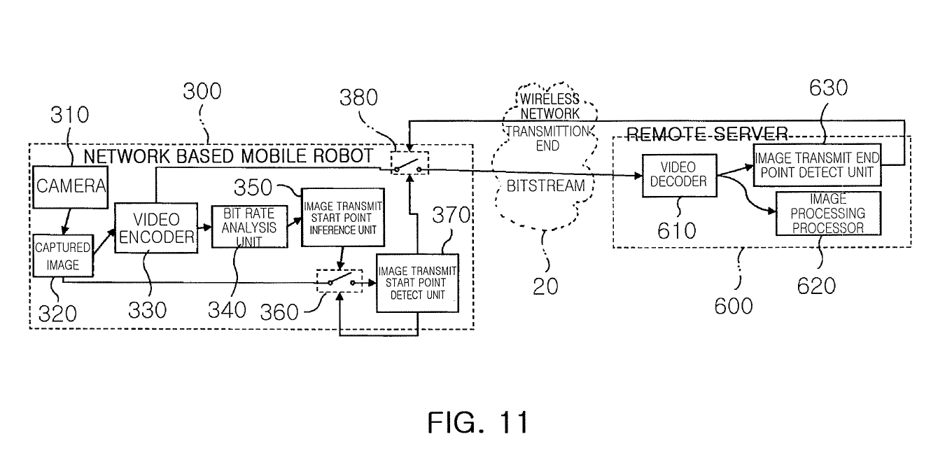

FIG. 11 is a block diagram illustrating a network-based mobile robot system for selectively outputting a captured image based on a motion of an object in an image according to a third embodiment of the present invention.

As shown, the network-based mobile robot 300 transmitting video data to the remote server 600 includes an image transmit start point inference unit 350 and an image transmit start point detect unit 370 beside of a camera 310, a video encoder 330, a bit rate analysis unit 340 and a switch unit 380.

The image transmit start point inference unit 350 determines a call start point of the image transmit start point detect unit 370 by examining the data obtained through the video encoder 330 and the bit rate analysis unit 340.

The switch unit 360 outputs the captured image 320 to the image transmit start point detect unit 370 according to the call start point determining result of the image transmit start point inference unit 350.

The image transmit start point detect unit 370 detects a motion made by an object through a low level differential image calculation for the captured image outputted form the switch unit 360 according to the call start point determining result of the image transmit start point inference unit 350.

In the present embodiment, the call start point of the image transmit start point detect unit 370 is determined through the variable bit rate video encoder 330, the bit rate analysis unit 340 and the image transmit start point inference unit 350. Also, it determines whether the variable bitstream is transmitted or not by the switch unit 380 based on the motion detecting through the differential image calculation of the image transmit start point detect unit 370. Therefore, the switch unit 380 transmits the variable bitstream to the remote server 600 through the wireless network 20 if the transmission start point is detected according to the motion detection by the image transmit start point detect unit 370.

In the present embodiment, the remote server 600 includes a vide decoder 610 for decoding bitstreams transmitted from the mobile robot 300, and an image transmit end point detect unit 630 for detecting a transmission end point of a bitstream from the decoded image data.

In the present embodiment, the process routine of detecting a bitstream transmission end point in the image transmit endpoint detect unit 630 will be described as follows. It determines an image transmit end point by determining whether an object moves or not from a video decoded image data. Herein, the remote server 600 transmits a transmit end instruction to the mobile robot 300 if the image transmit end point is detected. Thus, the switch unit 380 of the mobile robot 300 terminates the transmission of the bitstream.

The image transmit start point detect unit 370 stops the input of the captured image through the switch unit 360 if the number of a differential image pixel of a captured image is not beyond a fixed number for a predetermined time.

The present embodiment includes the image transmit start point detect unit 370 for accurately detecting a motion using an image analysis result, but its calling frequency is greatly reduced by image transmit start point inference unit 350 which nearly does not consume computing power. Therefore, the use rate of the processor of the mobile robot 300 can be reduced.

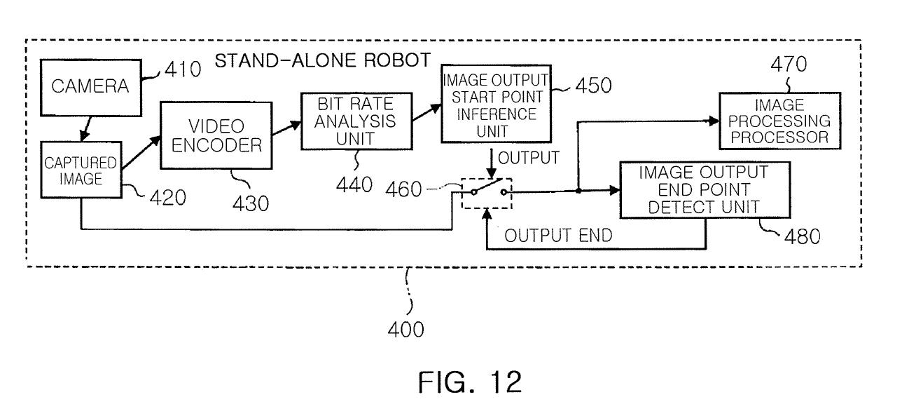

FIG. 12 is a block diagram illustrating stand-alone robot for selectively outputting a captured image based on a motion of an object in an image according to a fourth embodiment of the present invention.

In the present embodiment, a stand-alone robot 400 having a high performance level processor includes a camera 410, a video encoder for encoding captured images from the camera 410 based on a variable bit rate encoding mode, and a bit rate analysis unit 440, and an image output start point inference unit 450 for determining an output start point of a captured image. A switch unit 460 outputs the captured image 420 to an image process routine according to the inferring result of the image output start point inference unit 450.

The image output end point detect unit 480 determines whether the captured image 420 outputted from the switch unit 460 is passed or not. The image output end point detect unit 480 stops the output of the captured image 420 from the switch unit 460 through the image output end instruction.

In the present embodiment, the use rate of the mobile robot's processor is reduced by reducing the call frequency of the image processing processor 470 using bit rate information obtained through the video variable bit rate video encoder 430 without disturbing the performance of the main processor.

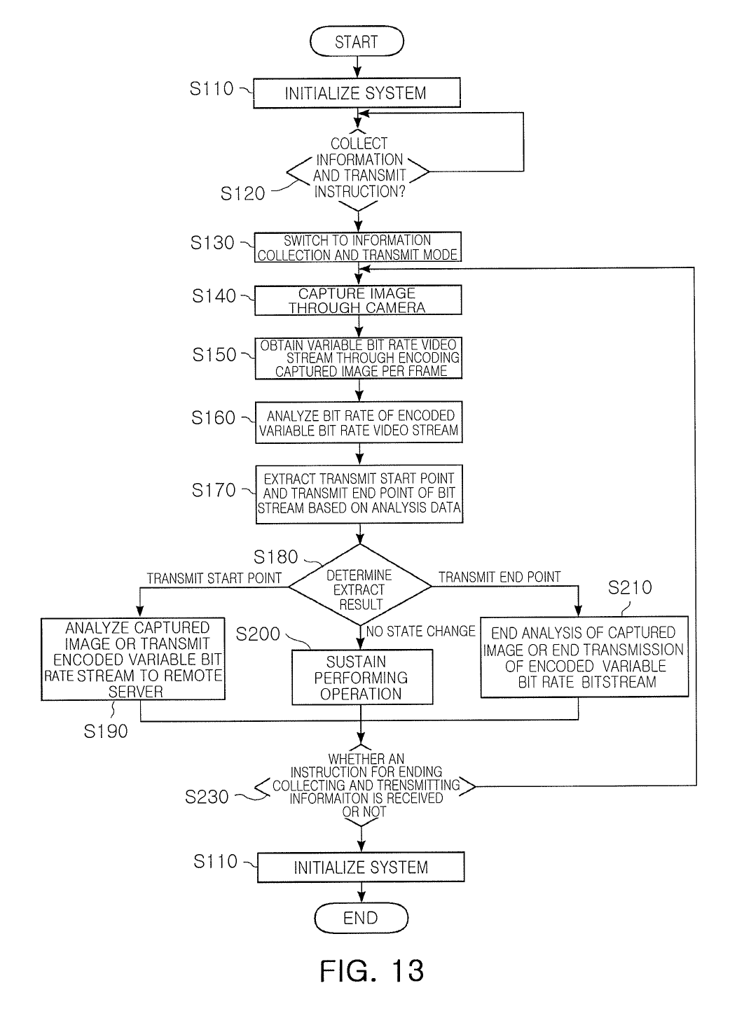

FIG. 13 is a flowchart illustrating a method of selectively outputting a captured image based on a motion of objects in an images at a network-based mobile system or a stand-alone robot according to an embodiment of the present invention.

As shown, if a power is supplied to the network-based mobile robot 100, the system thereof is initialized at step S110. Then, it determines whether the network-based mobile robot 100 receives instructions for image information collection or for transmitting the collected image information at step S120.

If the information collection and transmission instruction are inputted, the network-based mobile robot 100 switches to an operation mode for collecting information and transmitting the collected information at step S130. The network-based mobile robot 100 captures images through the camera 110 at step S140.

The network-based mobile robot 100 obtains a variable bit rate video stream from the video encoder 130 at step S150. The network-based mobile robot 100 analyzes the bit rate of the encoded variable bit rate video stream through the bit rate analysis unit 140 at step S160.

The network-based mobile robot 100 extracts a transmit start point and a transmit end point of a bitstream based on the bit rate analysis data through the image transmit start point/end point inference unit 150 at step S170.

Thus, the network-based mobile robot 100 judges the extracting result through the switch unit 170 at step S180. If the extracting result is the transmit start point, the network-based mobile robot 100 analyzes the captured image through the switch unit 170, or transmits the encoded variable bit rate bitstream to the remote server 600 at step S190. If the extracting result is the transmit end point, the network-based mobile robot 100 ends analysis of a captured image, or ends the transmission of the encoded variable bit rate bitstream at step S210. if the extracting result is “no state change”, The network-based mobile robot 100 sustains performing operation. If the network-based mobile robot 100 is in the process of transmitting data, the network-based mobile robot 100 continuously transmits data. If the network-based mobile robot 100 terminate the transmission of data, the network-based mobile robot 100 discards continuously data at step S200.

Then, the network-based mobile robot 100 determines whether an instruction for ending collecting and transmitting information are received or not at step S230. If the network-based mobile robot 100 determines that the instruction for ending collecting and transmitting information are received, the network-based mobile robot 100 initializes the system thereof at step S110. If not, the network-based mobile robot 100 performs the steps S140 to S210.

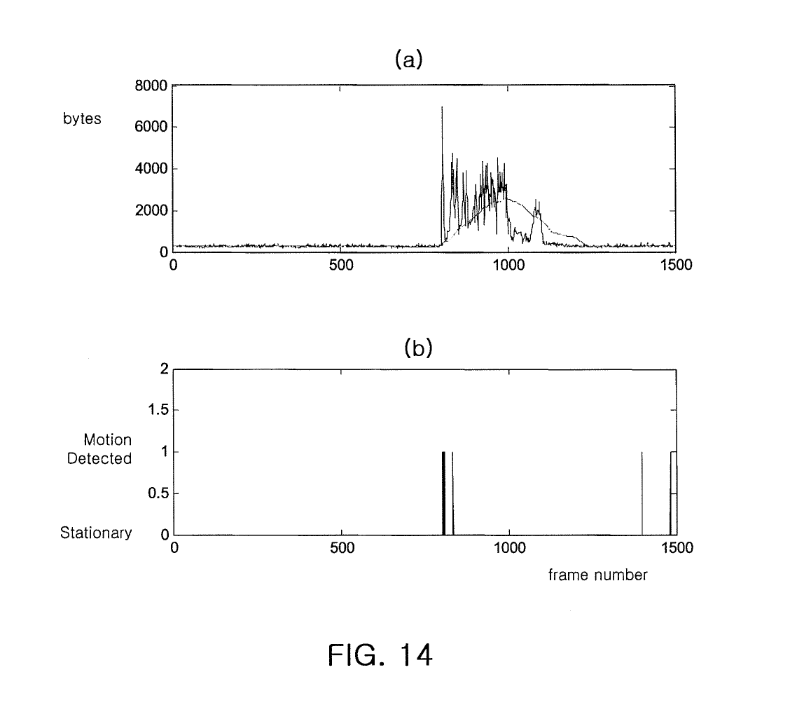

FIG. 14 to FIG. 19 are graphs for showing an example of detecting a start point by extracting a portion of image data of FIG. 4 and FIG. 5 through a network-based mobile robot 100 according to an embodiment of the present invention.

In these examples, the bit rate analysis unit 140 calculates a sample average m and a sample standard deviation σ of the 132 latest bitstream' size. In FIG. 14 to FIG. 19, graphs (a) show a bitstream size of each frame, and a sample average value. The image transmit start point/end point inference unit 150 decides a reference value m+3σ every moment using a sample standard deviation, and compares the average value of two bit steam size with the reference value. The image transmit start point/end point inference 150 determines that there is movement of the object in the captured image if the average value of two is larger than the reference value.

In FIG. 14 to FIG. 19, graphs (b) show the inference result of the image transmit start point/end point inference unit 150. If there is a motion in the captured image, 1 is marked. On the contrary, if there is no motion, 0 is marked in the graph. Once 1 is marked at the inference result graph of the image transmit start point/end point inference unit 150, it means that later frames are continuously utilized. Afterward, if the image is judged useless image, the frame activity stops by informing the image transmit start point/end point inference unit 150 of it.

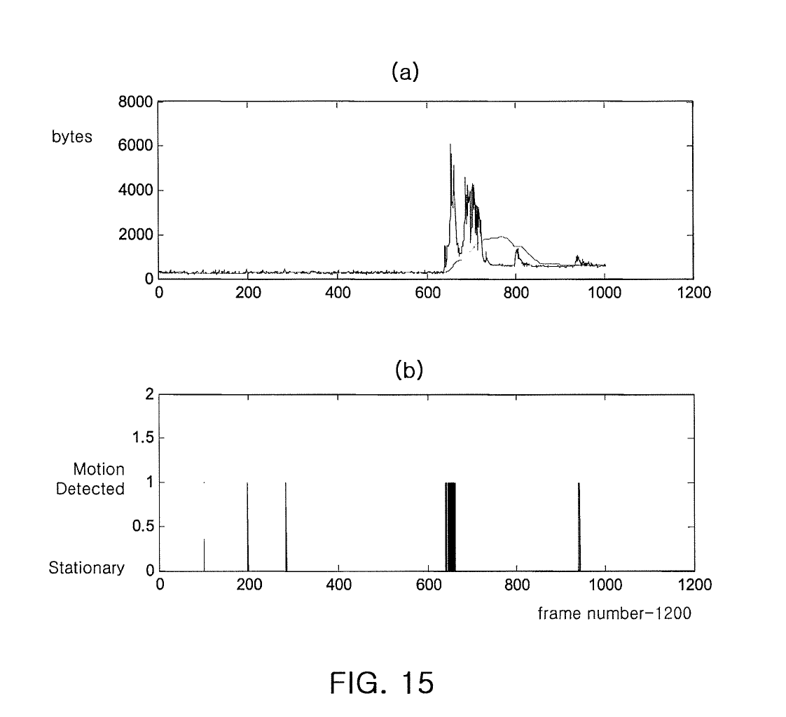

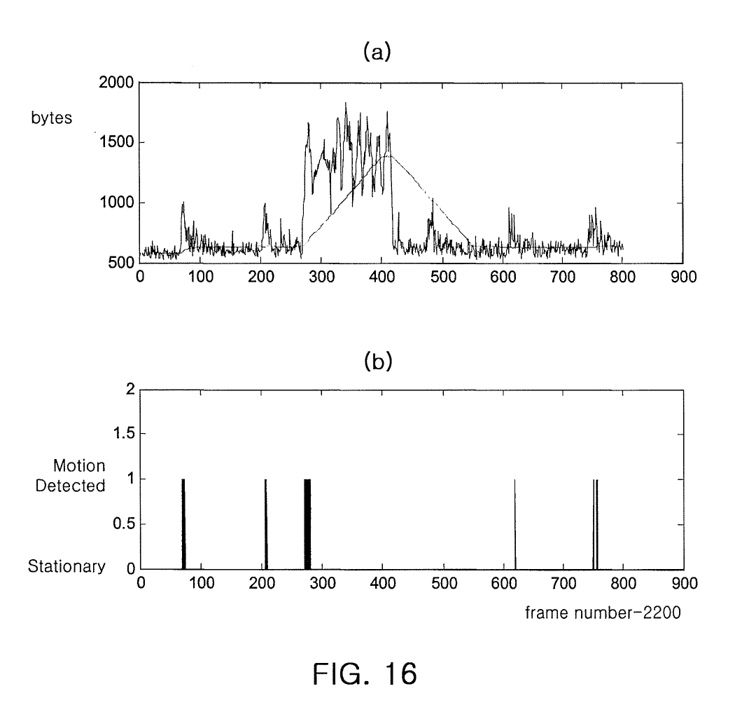

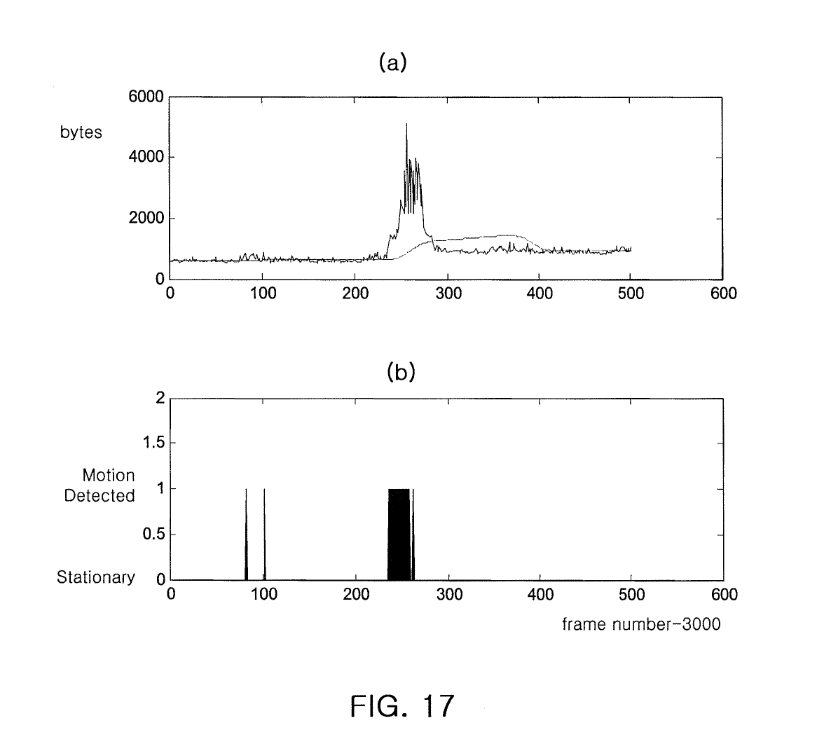

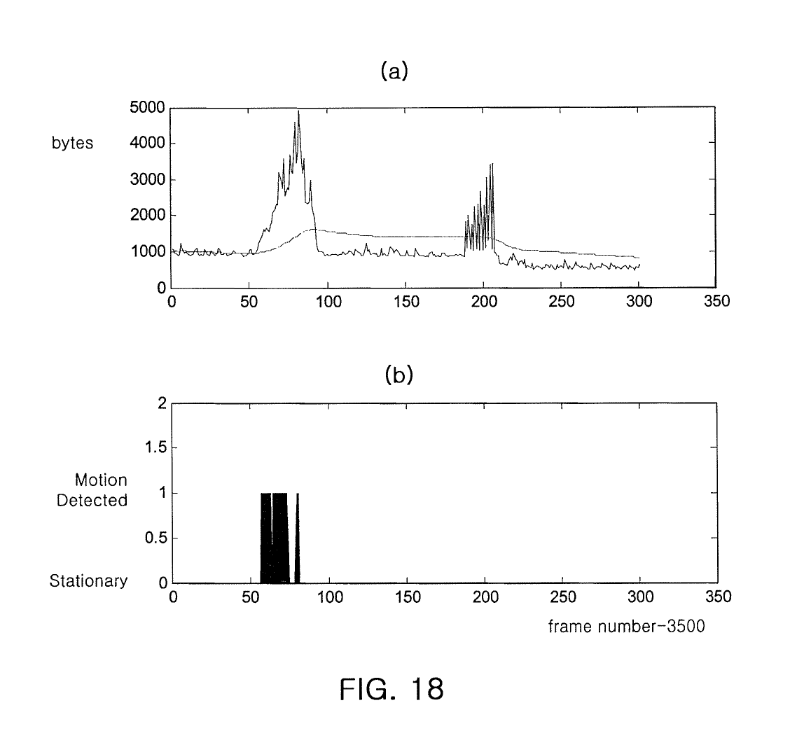

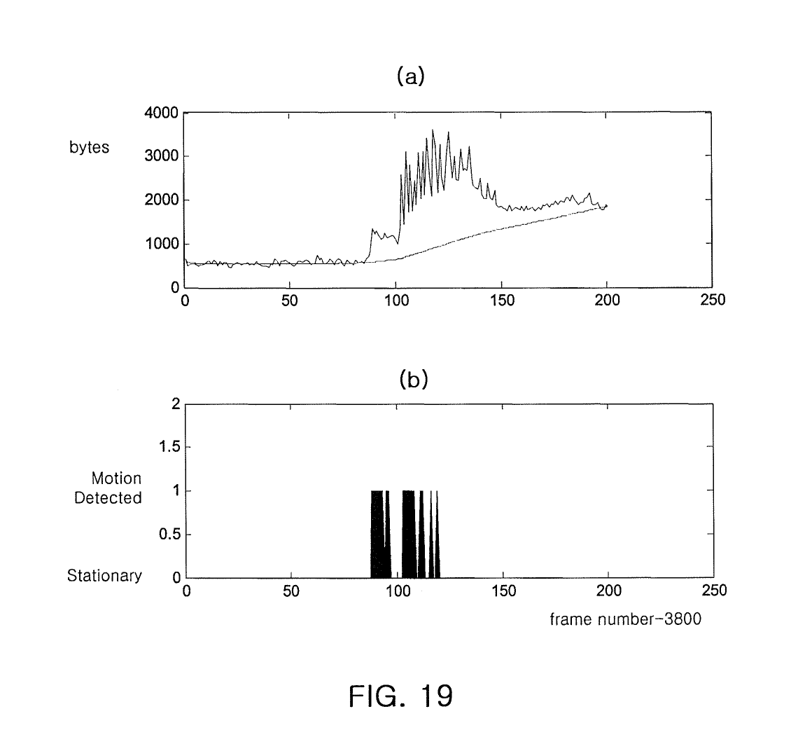

FIG. 14, FIG. 18 and FIG. 19 show that the start point can be accurately determined with the simple calculation and algorithm. On the contrary, FIG. 15, FIG. 16 and FIG. 17 show the cases of misdetermining a start point in case of no motion before the true start point although a true start point is accurately determined. However, in a case of misdetermining as a start point although it is not a start point, it will be discerned by an image analysis routine through an image processor 620, and the analysis and the utilization are terminated. Therefore, the loss thereof is not significant, and the frequency of misjudgments for starting image transmission can be reduced by updating a reference pint for determining the end point with reference to the result of the end point determining routine.

As set forth above, according to certain embodiments of the invention, in the network-based mobile robot system transmitting data of video format through a network, the mobile robot determines start point and end point of image transmission based on the size of the variable bitstream. According to the result thereof, the mobile robot selectively starts or ends the output of the input image to the internal image processor and selectively starts or ends the output of the bitstream to the remote server that processes images through a network. Therefore, unnecessary image transmission is previously blocked, thereby reducing network use rate. Also, the processing load of the remote server that receives image data from a plurality of mobile robots and processes them is reduced. Finally, single remote server can manage a lot of mobile robots, thereby providing an economic benefit.

In the network-based mobile robot system transmitting data of compressed video format through a network, the mobile robot determines start point and end point of image transmission based on the size of the variable bitstream, and selectively transmits image according to the determination result. Then, the mobile robot receives the image processing result from the remote server and performs related operations based on the received results. That is, the image processing load of the mobile robot can be reduced. Therefore, the manufacturing cost of the mobile robot can be reduced because the mobile robot can be embodied by equipping a low cost embedded processor.

While the present invention has been shown and described in connection with the preferred embodiments, it will be apparent to those skilled in the art that modifications and variations can be made without departing from the spirit and scope of the invention as defined by the appended claims.

What is claimed is:

1. A network-based mobile robot comprising:
a video encoder for encoding an inputted image with a variable bit rate to output bitstreams in a frame unit;
a bit rate analysis unit for analyzing a size of the bitstreams per frame outputted from the video encoder;
an inference unit for inferring output start point and output end point of the bitstream by comparing the size of the bitstreams with a predetermined reference value based on the analyzing result of the bit rate analysis unit and determining whether an object in the bitstreams per frame moves or not; and
a switch unit for selectively starting and ending the output of the bitstreams to a remote server based on a result of the inferring output start point and output end point by the inference unit, the remote server which is connected to a network and performing image processing.

2. The network-based mobile robot according to claim 1, wherein the switch unit selectively starts and ends the output of the inputted image to a built-in image processor based on a result of the inferring output start point and output end point by the inference unit.

3. The network-based mobile robot according to claim 1 or claim 2, wherein the bit rate analysis unit analyzes the size of the bitstreams per frame outputted from the video encoder by using at least one of time series analysis and frequency analysis.

4. The network-based mobile robot according to claim 3, wherein the time series analysis analyzes the size of the bitstreams per frame by using a sample average, a sample standard deviation, a sample maximum value, and a sample minimum value for N samples that are inputted the latest among the bitstreams per frame.

5. The network-based mobile robot according to claim 3, wherein the frequency analysis analyzes the size of the bitstreams per frame outputted from the video encoder by performing FFT conversion on N samples that are inputted the latest among the bitstreams per frame.

6. The network-based mobile robot according to claim 3, wherein the bit rate analysis unit performs filtering on N samples that are inputted the latest among the bitstream per frame to remove noises from the bitstreams before analyzing the size of the bitstreams per frame.

7. The network-based mobile robot according to claim 1, wherein the video encoder compresses and converts the input image into at least one of motion picture formats such as MPEG, H.263, and H.264 in a real time to encode the converted image with the variable bit rate.

8. The network-based mobile robot according to claim 7, wherein, when the output stop instruction is outputted by a inference engine, the inference unit resets the predetermined reference value based on the instruction.

9. The network-based mobile robot according to claim 1, wherein the inputted image is successive picture data captured in real time by a camera.

10. A network-based mobile robot comprising:
a video encoder for encoding an inputted image with a variable bit rate to output bitstreams in a frame unit;
a bit rate analysis unit for analyzing a size of the bitstreams per frame outputted from the video encoder;
an inference unit for inferring a bitstream output start point by comparing the size of the bitstreams to a predetermined reference value based on the analyzing result of the bit rate analysis unit and determining whether an object in the bitstreams per frame moves or not; and
a switch unit for starting the bitstream output operation to a remote server that is connected via a network and performs image processing, based on the inferring result of the inference unit, and ending the bitstream output operation when a transmit end instruction is inputted from the remote server through a transmit end point detecting process for the bitstreams.

11. The network-based mobile robot according to claim 10, wherein the video encoder compresses and converts the input image into at least one of motion picture formats such as MPEG, H.263, and H.264 in a real time to encode the converted image with the variable bit rate.

12. The network-based mobile robot according to claim 10 or claim 11, wherein the bit rate analysis unit analyzes the size of the bitstreams per frame outputted from the video encoder by using at least one of time series analysis and frequency analysis.

13. The network-based mobile robot according to claim 12, wherein the bit rate analysis unit performs filtering on N samples that are inputted the latest among the bitstream per frame to remove noises from the bitstreams before analyzing the size of the bitstreams per frame.

14. The network-based mobile robot according to claim 10, wherein, when the bitstream transmit end instruction is inputted, the inference unit updates the reference value based on the instruction.

15. A network-based mobile robot comprising:
a video encoder for encoding an input image with a variable bit rate to output bitstreams in a frame unit;
a bit rate analysis unit for analyzing a size of the bitstreams per frame outputted from the video encoder;
an inference unit for inferring a bitstream output start point by comparing the size of the bitstreams to a predetermined reference value based on the analyzing result of the bit rate analysis unit and determining whether an object in the bitstreams per frame moves or not;
a first switch unit for starting the image output operation in response to the inferring result of the inference unit, and ending the image output operation when a image output end instruction is inputted;
a detection unit for detecting a bitstream output start point and a bitstream output end point by comparing the next image of the outputted image from the first switch unit to a predetermined value and determining an object in the image moves or not, and inputting the image output end instruction to the first switch unit based on the image output end point; and
a second switch unit for starting the bitstreams output operation to a remote server that is connected via a network and performs image processing, based on the detecting result of the detection unit, and ending the bitstream output operation when a transmit stop instruction is inputted from the remote server through a transmit end point detecting process for the bitstreams.

16. The network-based mobile robot according to claim 15, wherein the video encoder compresses and converts the input image into at least one of motion picture formats such as MPEG, H.263, and H.264 in a real time to encode the converted image with the variable bit rate.

17. The network-based mobile robot according to claim 15 or claim 16, wherein the bit rate analysis unit analyzes the size of the bitstreams per frame outputted from the video encoder by using at least one of time series analysis and frequency analysis.

18. The network-based mobile robot according to claim 15, wherein the bit rate analysis unit performs filtering on N samples that are inputted the latest among the bitstream per frame to remove noises from the bitstream before analyzing the size of the bitstream per frame.

19. The network-based mobile robot according to claim 15, wherein, when the bitstream transmit stop instruction is inputted from the remote server, the inference unit updates the reference value based on the instruction.

20. The network-based mobile robot according to claim 15 or claim 19, wherein, when the bitstream transmit stop instruction is inputted from the remote server, the detection unit updates the value based on the instruction.

21. A method of transmitting image data using a network-based mobile robot, the method comprising:
encoding an input image with a variable bit rate to output bitstreams in a frame unit;
analyzing the size of the outputted bitstreams per frame;
comparing the size of the bitstreams to a predetermined reference value based on the analyzing result, and determining whether an object in the bitstreams per frame moves or not;
inferring a bitstream output start point based on the determining result;
starting the bitstream output operation to a remote server that is connected via a network and performs image processing based on the inferring result; and
ending the bitstream output operation when a transmit stop instruction is inputted from the remote server through a transmit end point detecting process for the bitstreams.

22. The method according to claim 21, wherein in the step of encoding an input image with a variable bit rate to output bitstreams in a frame unit, the input image is compressed and converted into at least one of motion picture formats such as MPEG, H.263, and H.264 in a real time to encode the converted image with the variable bit rate.

23. The method according to claim 21 or claim 22, wherein in the step of analyzing a size of the outputted bitstreams per frame, the size of the outputted bitstreams per frame is analyzed by using at least one of time series analysis and frequency analysis.

24. The method according to claim 21, wherein in the step of analyzing a size of the outputted bitstreams per frame, filtering is performed on N samples that are inputted the latest among the bitstream per frame to remove noises from the bitstream before analyzing the size of the bitstream per frame.

25. The method according to claim 21, further comprising:
determining whether a bitstream output stop instruction is inputted or not by means of motion detecting process routine at the remote server, and
ending the bitstreams output operation if the bitstream output stop instruction is inputted.

26. The method according to claim 25, further comprising:
if the bitstream output stop instruction is inputted, updating the reference value based on the instruction.

27. A method of transmitting image data using a network-based mobile robot, the method comprising the steps of:
encoding an input image with a variable bit rate to output bitstreams in a frame unit;
analyzing a size of the outputted bitstreams per frame;
comparing the size of the bitstreams to a predetermined reference value based on the analyzing result, and determining whether an object in the bitstreams per frame moves or not;
inferring a bitstream output start point and a bitstream output end point based on the determining result;
outputting selectively the input image to an internal image processor and the bitstreams to a remote server that is connected via a network and performs image processing, based on the inferring result.

28. A method of transmitting image data using a network-based mobile robot, the method comprising the steps of:
encoding an input image with a variable bit rate to output bitstreams in a frame unit;
analyzing a size of the outputted bitstreams per frame;
comparing the size of the bitstreams to a predetermined reference value based on the analyzing result, and determining whether an object in the bitstreams per frame moves or not;
inferring a bitstream output start point based on the determining result;
starting the image output operation in response to the inferring result;
detecting a bitstream output start point and an image output end point by comparing the next image of the outputted image to a predetermined value and determining an object in the image moves or not, and controlling the image output end based on the detected image output end point;
starting the bitstreams output operation to a remote server that is connected via a network and performs image processing, based on the detected output start point; and
stopping the bitstream output operation when a transmit stop instruction is inputted from the remote server through a transmit end point detecting process for the bitstreams.
